(19) United States
(12) Patent Application Publication
(10) Pub. No.: US 2006/0082872 A1
(43) Pub. Date: Apr. 20, 2006

(54) Apparatus for making celestial observations

(76) Inventors: John F. Acres, Corvallis, OR (US); Andrew Emang, Corvallis, OR (US)

Correspondence Address: MARGER JOHNSON & MCCOLLOM, P.C., 210 SW MORRISON STREET, SUITE 400, PORTLAND, OR, 97204, US

(21) Appl. No.: 11/255,254

(22) Filed: Oct. 20, 2005

Related U.S. Application Data
(60) Provisional application No. 60/620,958, filed on Oct. 20, 2004.

(51) Int. Cl. G02B 23/00

(52) U.S. Cl. 359/414

(57) ABSTRACT

A commercially-available chair is mounted on a rotatable platform. A U-shaped binocular mount is pivotally attached to either side of the chair to permit rotation between a first position in which binoculars received in the binocular mount are substantially in front of a person seated in the chair to a second position in which such binoculars are substantially over the head of the person. Counterweights on each end of the binocular mount offset the weight of the binoculars. The binocular mount is also slidable along its axis to permit movement of the binoculars toward and away from the face of a person in the chair. And binoculars in the binocular mount may pivot around an axis substantially through the binoculars. Platform rotation is accomplished with a battery-powered motor.

### CROSS REFERENCE TO RELATED APPLICATIONS

This application claims priority from U.S. Provisional Application No. 60/620,958, filed on Oct. 20, 2004, entitled APPARATUS FOR VIEWING THE NIGHT SKY, the contents of which are herein incorporated by reference for all purposes.

### BACKGROUND OF THE INVENTION

This invention describes an easily transportable and comfortable motorized pivoting chair for viewing the night sky, particularly with binoculars.

Persons interested in astronomy often use binoculars to magnify images of night sky objects. As binocular magnification and weight increases it becomes more difficult to hold binoculars steadily by using hands. It is especially uncomfortable to view objects when they are well above the horizon and difficult to retain a stable and comfortable position while rotating to view different areas of the sky.

### SUMMARY OF THE INVENTION

This invention offers a collapsible, lightweight chair mounted on a motorized platform allowing the chair to rotate 360 degrees in azimuth, leaving the user in a consistently comfortable position. Also provided is a lightweight binocular mount that attaches to the chair and conveniently positions the binoculars in front of the user's eyes. A laser beam is mounted in alignment with the optical axis of the binoculars to assist in aiming.

### BRIEF DESCRIPTION OF THE DRAWINGS

FIG. 1 is a perspective view of a device constructed in accordance with the invention.

FIG. 2A is a top plan view of the platform of FIG. 1.

FIG. 2B is a side elevation view of the platform of FIG. 2A.

FIG. 3 is a schematic diagram of a motor control incorporated in the device of FIG. 1.

FIG. 4 is an enlarged perspective view of a portion of the device of FIG. 1.

FIG. 5 is an enlarged partial view of a portion of the device in FIG. 4 also showing a portion of the chair from FIG. 1.

FIG. 6 is an enlarged partial view of a portion of the device in FIG. 4.

### DETAILED DESCRIPTION OF THE PREFERRED EMBODIMENT

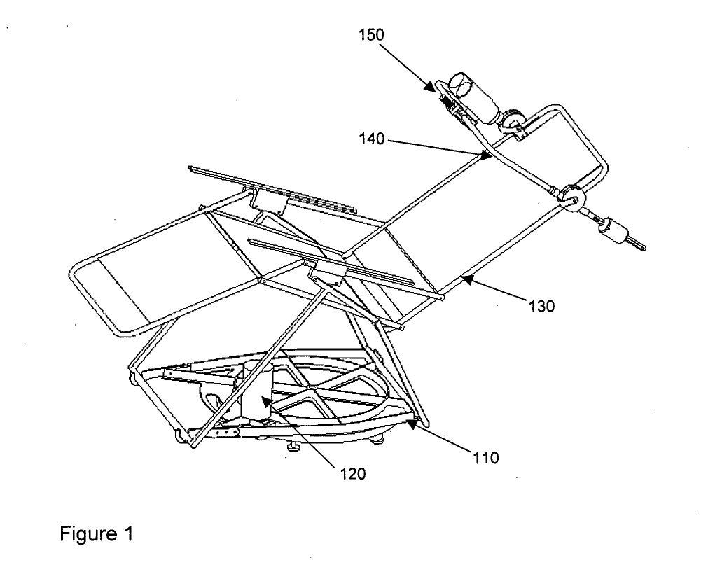

An embodiment of the invention provides a convenient means of viewing the entirety of the night sky in a highly transportable configuration. Another embodiment provides a convenient means of supporting binoculars for comfortable and stable viewing. FIG. 1 illustrates the rotating platform 110, motor 120, chair 130, binocular mount 140 and binocular head 150. The user causes the chair to move in a clockwise or counterclockwise (azimuth) direction by use of the motor control. Changes in pitch (altitude) are made by pushing the binocular mount up or down. The chair is easily detached from the rotating platform for easy transportation.

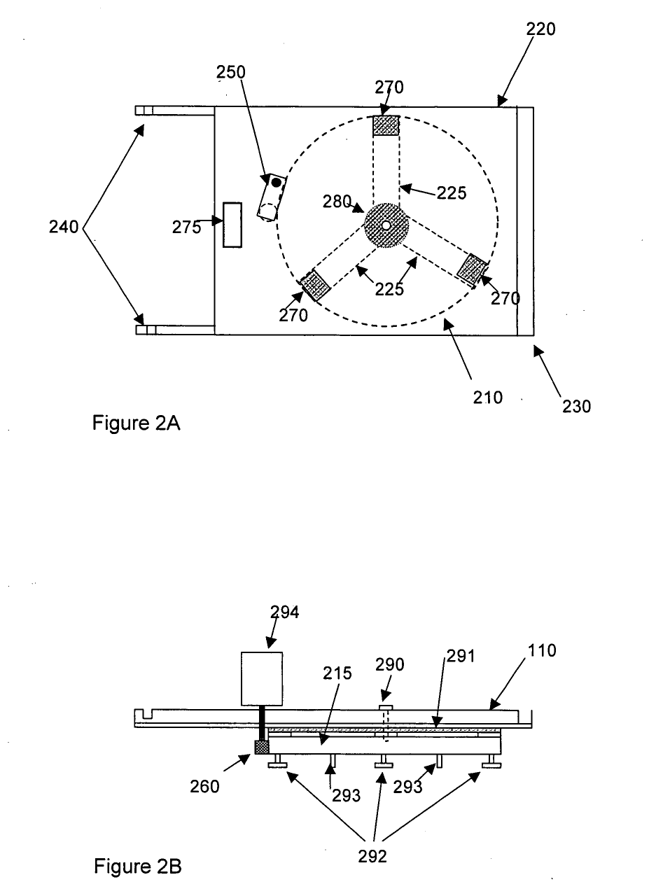

FIGS. 2a and 2b depict top and side views of the rotating platform 110 which consists of a base ring 210, platform plate 220, rear chair channel 230, front chair grasps 240, drive wheel tensioner 250 and drive wheel 260. Also shown are three outside bearing pads 270, center bearing pad 280 and center pivot 290.

Additionally shown are platform plate bearing surface 291, three outside bearing feet 292 and three stabilizing feet 293, of which only two are visible. Motor 294 completes the illustration.

Motor 294 is directly coupled to drive wheel 260 and the drive wheel is frictionally coupled to the outside surface of the base ring 210 by drive wheel tensioner 250. The drive wheel is caused to turn when the motor is powered and rotates the platform plate, 220, along with the chair and the user it supports. Motor direction and speed are controllable and dictates the direction and speed of platform rotation.

The rotating platform is most comfortable and efficient when it rests in a level plane. Three bearing feet 292 are spaced equally around the base ring. By adjusting the height of each bearing foot the base ring can be brought to level on uneven surfaces. Three stabilizing feet 293 are spaced at equal distances around the base ring at locations midway between the three bearing feet to prevent tipping when the user's weight is rotated at positions between the bearing feet. The stabilizing feet are adjusted in height to just make contact with the ground and are not intended to carry a load except during brief times of instability due to a shift of weight by rotation or use movement.

Directly above each bearing foot is a low friction bearing 270. A preferred embodiment uses Teflon as the low friction bearing material. All system weight, which is the combined weight of the platform plate, chair, user and equipment, is carried through these three low friction bearing surfaces and the center bearing pad. By locating each directly over a bearing foot, system weight is efficiently coupled to the ground surface, thereby enhancing mount stability.

A center bearing pad is located at the center point of the mount. This pad is shimmed to be several tens of thousandths, typically forty thousandths, of an inch higher than the outside bearing feet in order to place a significant proportion of the system weight onto this center bearing and thereby reduce the force required to rotate the platform. A continuous surface of Fiberglass Reinforced Plastic, FRP, is attached to the bottom of the platform plate and provides a low friction surface 291 that mate with the base ring's four bearing pads. The method of using FRP, Teflon bearing surfaces and shims to raise the center bearing is well known to those skilled in the art of designing or building telescope mounts.

A unique aspect of this invention is combining the base ring 210, leveling feet 292, stabilizing feet 293, bearing pad supports 270, driving surface 215 and center support spans 225 into a single lightweight assembly. It is important that the outside bearing surfaces of the base ring are on a common plane and that the center bearing is on a parallel but slightly elevated plane than the outside bearing surfaces. Also important is that the drive ring driving surface 215 is concentric to the center pivot bolt 290, with a surface that is smooth but provides adequate friction to reliably couple with drive wheel 260. Center support spans 225 must be strong enough to carry the weight assigned to the center bearing surface without drooping more than the shim height.

A preferred embodiment is to cast the base ring 210, including its driving surface 215 bearing pad mounting areas, center bearing mounting area and center support spans 225 as a single unit of lightweight metal such as aluminum, though other metals such as magnesium may also be used. Plastic is an alternative material. The center shim is either cast into the base ring or implemented using a separate shim.

A preferred embodiment of the platform plate is the use of a relatively thin bottom surface plate with vertical ribs to provide rigidity and strength with a minimum of weight. A preferred method of building the platform plate is by casting it of metal. Another preferred method is to mold it of plastic. Front chair grasps 240 may be cast or molded as an integral part of the platform plate or constructed separately and connected to the platform plate. A preferred embodiment places the chair grasps on hinges so they fold back to reduce the overall size of the rotating platform during transportation.

Carrying handle 275 provides a convenient handhold and in a preferred embodiment is cast or molded into the platform plate. The surrounding edges of the carrying handle are made thicker than the overall platform plate in order to improve carrying comfort.

Base ring 210 is affixed to platform plate 220 with a center bolt that also serves as the pivot point. The FRP bearing is sandwiched between the base ring and platform plate and attached to the bottom of the platform plate.

The wheel tensioner is a spring loaded arm coupled to the drive wheel. The motor mounts directly above the drive wheel. The wheel tensioner maintains frictional contact between drive wheel and drive ring driving surface and accommodates minor surface irregularities in either the drive wheel or drive ring surface.

A preferred embodiment has one or more flat sides on the motor shaft. The drive wheel has a socket shaped to closely fit the motor shaft and the motor is installed or removed by aligning the motor shaft flats with the flats in the drive wheel socket. The motor container includes a hole that mates with a protrusion from the drive wheel tensioner. Once the motor shaft is partially inserted into the drive wheel socket the motor is rotated until the motor container hole is aligned with the protrusion from the drive wheel tensioner. At that point the motor shaft is allowed to drop fully into the drive wheel socket which also causes the drive wheel tensioner protrusion to engage with the hole in the motor container. This process fixes the motor to the platform plate through the drive wheel tensioner and prevents the motor container from turning. Once mounted in this position, motor rotation will be coupled into the drive wheel and thereby cause the platform plate and its system load to rotate.

A preferred embodiment encloses the motor, motor control electronics and battery into the motor container.

A preferred chair 130 embodiment uses commercially available La Fuma “zero gravity chair” or Travel Chair Company “lounge lizard chair”. Other chairs may be used so long as their frames mate properly with the front chair grasps and rear chair channel.

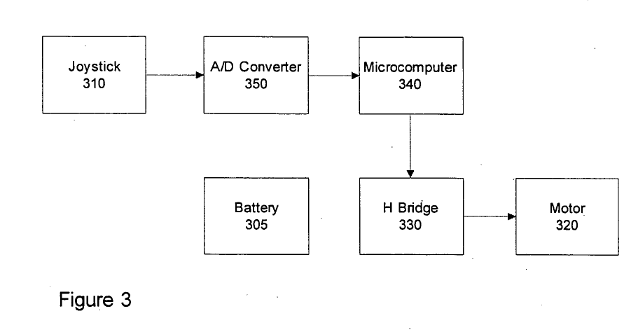

Chair rotation is activated by a control system, FIG. 3, mounted in a convenient location and coupled to the motor control electronics powered by battery 305. The motor control may be a series of switches, each associated to a specific direction and speed of rotation. A preferred embodiment is a joystick 310 with a signal output that changes in proportion to the direction and distance in which it is pressed. One such joystick is the CTS Corp, type 252 ministick which attaches a center spring loaded handle to a variable resistor. The handle can be pushed in one direction or the other and is held at rest in a center position by springs. A voltage is applied across the variable resistor and its output voltage varies with the location of the central resistor wiper creating a voltage output that is in proportion to where the joystick handle is positioned.

The motor 320 must turn in either clockwise or counterclockwise direction. An H bridge circuit 330, which is well known to those skilled in motor control design, is a preferred means of controlling motor speed and direction. A microprocessor 340 or discrete electronic logic is connected to the joystick output and the H-bridge input. The joystick position is read by the microprocessor through an A-D converter 350. The microprocessor then outputs a pulse width modulated signal in proportion to desired motor speed for the joystick position and also outputs a direction signal that is also determined from the joystick position.

Those skilled in the art of motor control will be familiar with circuits such as that just described and with other circuits that perform similar function. Other input devices, including but not limited to touch pads, pointing sticks and trackballs may be used. All such variations are anticipated in this invention.

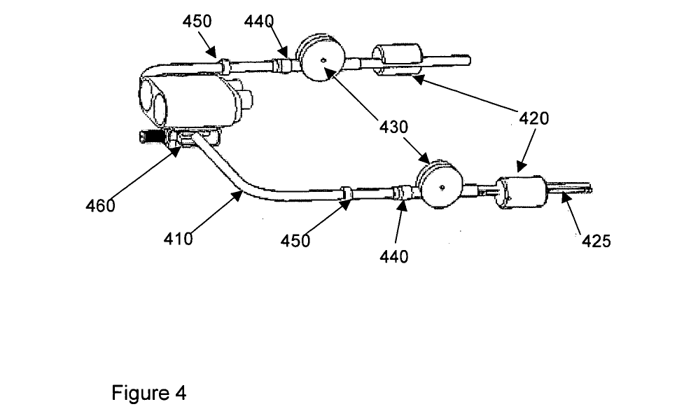

The binocular mount is represented in FIG. 4. One pivot clamp 430 attaches to each side of the chair frame. A frictional coupling 440 passes through, and is held in place by, each pivot clamp. One side of the U bar 410 passes through each frictional coupling. Counterweight brackets 425 are attached to each side of the U bar (only one is visible in FIG. 4) and a counterweight 420 slides over each side of the combined U bar and counterweight bracket. Protrusions on each end of the counterweight brackets limit the length of travel of the counterweights in each direction. The forward end of each counterweight bracket further serves as a stop that prevents moving the U bar too far forward.

Each counterweight is mounted off-center from the U-bar so as to move the body of the counterweight further from the chair. This allows the counterweight to be mounted closer to the chair frame without hitting the chair frame when the counterweights are swung down beside the chair frame. This off-center mounting reduces the size of each pivot clamp while providing enough clearance to prevent the counterweight from striking the chair frame, making the overall assembly smaller and more easily transported.

Counterweights are allowed to slide well past the open ends of the U bar to provide a wider counterbalance range. The rear protrusion of each counterweight bracket prevents the counterweights from sliding completely off the U bar.

The binocular head mounts in the center of the closed end of the U bar.

Counterweights are moved to a point on the U bar at which the weight of the binocular mount is approximately offset at the pivot point. This counterbalancing allows easy adjustment of the pitch direction of the binoculars and holds the binoculars in a chosen position without additional support from the user. The counterweights are held in place by screw clamps (not shown). The U bar pivots over a range of greater than 180 degrees, allowing the user to aim the binoculars at any desired pitch angle.

The U bar is constructed with a smooth finish. A preferred embodiment is anodized aluminum. Each frictional coupling 440 provides a consistent amount of friction against the U bar. The amount of friction is chosen to be enough to prevent the U bar from sliding downward through the frictional coupling when the binoculars are aimed at areas near the zenith. A preferred embodiment uses Teflon to construct the frictional couplings. The user is able to slide the binoculars forward and back by pushing or pulling on the U bar and adjust the binoculars to a comfortable position.

In order to strike a balance between the higher friction required to hold the binoculars in place and the lower friction required for easy user adjustment, a preferred embodiment sets the frictional coupling friction at a value where it can hold the binoculars stationary in most pitch angles. When the binoculars are pointed at zenith, the force of gravity is greatest as the entire binocular mount weight is applied against the frictional couplings. A movable frictional stop 450 is placed in front of each frictional clamp. When the binoculars are pointed at or very near zenith, these frictional stops come into contact with the frictional couplings and supply additional resistance against the pull of gravity. A preferred embodiment uses plastic to construct the frictional stops, the inside diameter of which is set to provide only a couple of pounds of friction. This allows the user to move the frictional stops forward and back simply by pushing or pulling on the clamp. Alternatively, an adjustable clamp could be used.

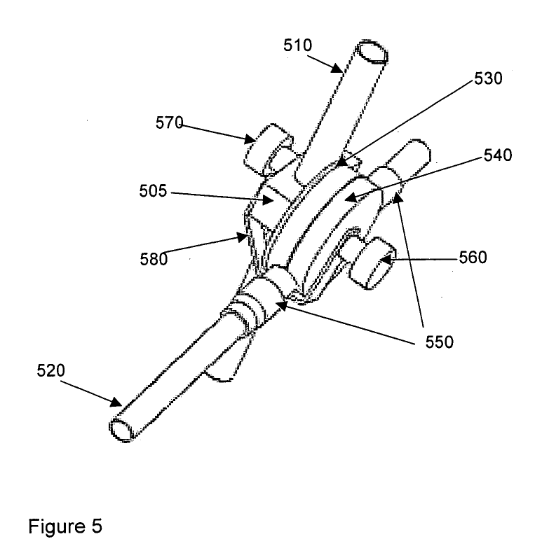

One pivot clamp is placed on each side of the chair frame. FIG. 5 illustrates the left side pivot clamp (as seen from the back of the chair). The right side pivot clamp is identical in function. Chair frame block 505 is constructed to fit snugly around the chair frame tube 510. A screw is connected to pivot plate 530 and passes through the chair frame block behind the opening through which the chair frame tube passes. When chair frame tensioning knob 570 is loose, the pivot clamp is adjustable up or down along the chair frame tube for maximum user comfort. Once the pivot clamp is in place, the chair frame tensioning knob is tightened to hold it there.

Pivot cylinder 540 is sliced halfway along its height to a point just past its center. Just beneath this slice, a hole provides passageway for frictional clamp 550. A screw is attached to the chair frame block side of the V clamp 580. The screw passes through the chair frame block and extends through the center of the pivot cylinder where pivot tension knob 560 is attached. The pivot tension knob is adjusted to provide the desired amount of friction to the pivot clamp and determines the amount of force required to change the pitch angle of the U bar 520 which passes through the frictional clamp.

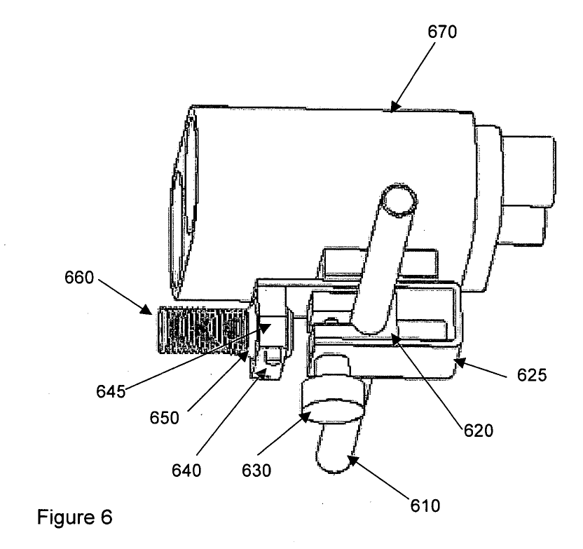

Binocular head 460 is illustrated more completely in FIG. 6. The binoculars 670 mount on top of C clamp 625 through a screw or other coupling. Friction block 620 is mounted over the U bar. Binocular tilt tensioning knob 630 is attached to a screw which passes through friction block 620 and anchor in C clamp 625. The entire binocular head assembly is tiltable around the U bar. The amount of force required to tilt the binocular head is adjusted by tightening or loosening the tilt tensioning knob 630.

A laser module is inserted into gimbal 650, which allows the laser body to be tilted in pitch and yaw directions. Laser tensioning knob 640 is attached to a screw which in anchored in the opposing side of gimbal frame 645 and controls the force required to move the laser body. The laser serves to provide binocular aiming assistance. To align the laser with the binocular, the user looks through the binocular and adjusts the laser in pitch and yaw until it is visible in the proximate center of the binocular field of view. Once so aligned, the user can easily aim the binocular by rotating the chair in azimuth through motor control and adjusting the combined pitch of the U bar and binocular mount so as to point the laser at the desired target. Once aligned, the user can look through the binocular to see a magnified view.

Having described and illustrated the principles of the invention in a preferred embodiment thereof, it should be apparent that the invention can be modified in arrangement and detail without departing from such principles. I claim all modifications and variation coming within the spirit and scope of the following claims.

1. Apparatus for making celestial observations comprising:
a rotatable platform;
a chair mounted on the platform; and
a binocular mount adjustably coupled to the chair in position for a user seated in the chair to look at the sky through a pair of binoculars received in the binocular mount, the binocular mount being pivotally attached to the chair on both sides thereof.

2. The apparatus of claim 1 wherein the apparatus further comprises a laser mount adjustably coupled to the binocular mount.

3. The apparatus of claim 2 wherein the laser mount is constructed and arranged to permit aiming a laser received in the laser mount at the same location as binoculars received in the binocular mount.

4. The apparatus of claim 1 wherein the apparatus further includes a motor for rotating the platform in response to signals from the controller.

5. The apparatus of claim 4 wherein the apparatus further includes a battery to power the motor.

6. The apparatus of claim 1 wherein the binocular mount includes at least one arm constructed and arranged for axial movement to permit binoculars received in the binocular mount to move toward and away from the face of a person seated in the chair.

7. The apparatus of claim 1 wherein the binocular mount includes a counterweight to balance the weight of the binoculars.

8. The apparatus of claim 1 wherein the binocular mount comprises a U-shaped element having the binoculars attachable at substantially the center of the element and a counterweight mounted on the element to offset the weight of an attached pair of binoculars.

9. The apparatus of claim 1 wherein the platform is constructed and arranged to permit a conventional, commercially-available chair to mount on the platform and the binocular mount is constructed and arranged to mount on such a chair.

10. The apparatus of claim 1 wherein the apparatus further includes a controller connected to the platform to control platform rotation in response to input signals generated by a user seated in the chair.

11. The apparatus of claim 10 wherein the binocular mount includes a counterweight to balance the weight of the binoculars.

12. Apparatus for making celestial observations comprising:
a chair;
an arm pivotally attached to the chair for rotation in a substantially vertical plane from a first position substantially in front of a person seated in the chair to a second position substantially over the head of such a person; and
a binocular holder attached to the arm to hold a pair of binoculars through which a person seated in the chair may view portions of the sky depending on the position of the arm.

13. The apparatus of claim 12 wherein the apparatus further comprises a laser mount adjustably coupled to the binocular holder.

14. The apparatus of claim 13 wherein the laser mount is constructed and arranged to permit aiming the laser at the same location as binoculars received in the holder.

15. The apparatus of claim 12 wherein the apparatus further includes a platform to hold the chair and a motor to rotate the platform.

16. The apparatus of claim 15 wherein the apparatus further includes a battery to power the motor.

17. The apparatus of claim 12 wherein the platform is constructed and arranged to permit a conventional, commercially-available chair to mount on the platform and the binocular mount is constructed and arranged to mount on such a chair.

18. The apparatus of claim 12 wherein the arm includes a counterweight to balance the weight of binoculars received in the holder.

19. The apparatus of claim 12 wherein the arm comprises a U-shaped element having the binocular holder substantially at the center of the element and a counterweight mounted on the element to offset the weight of a pair of binoculars held in the holder.

20. The apparatus of claim 12 wherein the arm comprises an arm constructed and arranged for axial movement to permit binoculars received in the binocular holder to move toward and away from the face of a person seated in the chair.

21. Apparatus for making celestial observations comprising:
a rotatable platform;
a chair mounted on the platform;
a mount adjustably coupled to the chair in position for a user seated in the chair to look at the sky through an optical device received in the mount, the mount constructed and arranged to permit movement of such an optical device toward and away from the face of a person seated in the chair;
a motor to rotate the platform; and
a battery for powering the motor.

22. The apparatus of claim 21 wherein the apparatus further comprises a laser holder adjustably coupled to the mount.

23. The apparatus of claim 21 wherein the mount comprises a U-shaped element having the optical device attachable at substantially the center of the element and a counterweight mounted on the element to offset the weight of an optical device received in the mount.

24. The apparatus of claim 21 wherein the platform is constructed and arranged to permit a conventional, commercially-available chair to mount on the platform and the mount is constructed and arranged to couple to such a chair.

25. The apparatus of claim 21 wherein the mount is pivotally attached to the chair for rotation in a substantially vertical plane from a first position substantially in front of a person seated in the chair to a second position substantially over the head of such a person.

26. The apparatus of claim 25 wherein the optical device is attached to the mount to permit rotation of the device about an axis substantially through the device.
